(19) United States
(12) Patent Application Publication
(10) Pub. No.: US 2025/0023313 A1
(43) Pub. Date: Jan. 16, 2025

(54) CORE WIRE ALIGNMENT APPARATUS FOR MULTI-CORE CABLE

(71) Applicant: Shinmaywa Industries, Ltd., Takarazuka-shi, Hyogo (JP)

(72) Inventors: Hiroaki SHIRAI, Takarazuka-shi (JP); Motoi OKADA, Takarazuka-shi (JP); Yoshiki TAKAHASHI, Takarazuka-shi (JP); Morihiro OKADA, Takarazuka-shi (JP)

(21) Appl. No.: 18/695,030

(22) PCT Filed: Sep. 20, 2022
(86) PCT No.: PCT/JP2022/034996

§ 371 Date: Oct. 3, 2024

(30) Foreign Application Priority Data
Sep. 28, 2021 (JP) 2021-158371

(51) Int. Cl. H01R 43/28

(52) U.S. Cl. CPC H01R 43/28

(57) ABSTRACT

A core wire alignment apparatus 10 according to the present invention includes a first grip member 21 gripping a multi-core cable 1 including a plurality of core wires 2; an alignment member 81 including a plurality of comb teeth 81a inserted between the plurality of core wires 2, and a bending device 30 bending the plurality of core wires 2 such that the core wires 2 protrude in a direction crossing an axial direction of the core wires 2 to form bent portions 2a in the plurality of core wires 2. The bending device 30 forms the bent portions 2a between portions of the core wires 2 that are gripped by the first grip member 21 and portions of the core wires 2 into which the comb teeth 81a are inserted. The core wire alignment apparatus 10 performs a bending control of controlling the bending device 30 to form the bent portions 2a in the plurality of core wires 2, and an alignment control of, after the bending control, inserting the plurality of comb teeth 81a between the plurality of core wires 2.

### TECHNICAL FIELD

The present invention relates to a core wire alignment apparatus for a multi-core cable.

### BACKGROUND ART

Conventionally, a plurality of core wires of a multi-core cable are aligned before a terminal is crimped on the core wires of the multi-core cable. For example, Patent Literature 1 discloses a method by which a plurality of core wires are inserted into a global pitch alignment jig and sandwiched like being clamped and secured to be in a parallel state at a certain narrow pitch. The global pitch alignment jig described in Patent Literature 1 includes a sheath hole into which a sheath of the multi-core cable is inserted and a plurality of core wire holes branched from the sheath hole and each allowing one core wire, among the plurality of core wires, to be inserted thereinto.

### CITATION LIST

### Patent Literature

Patent Literature 1: Japanese Laid-Open Patent Publication No. 2010-3429

### SUMMARY OF INVENTION

### Technical Problem

FIG. 17 is a plan view of a multi-core cable 1 considered to be formed by aligning core wires 2 by use of the global pitch matching jig described in Patent Literature 1. When the core wires 2 are aligned by the global pitch matching jig described in Patent Literature 1, the core wires 2 at an end in an alignment direction thereof (up-down direction in the sheet of FIG. 17), for example, a core wire 2R at a bottom end is bent such that a tip thereof is moved downward in the sheet of FIG. 17. As a result, the tip of the core wire 2R is retracted to a position closer to a base of the core wires 2 than a tip of a core wire 2C at the center. As shown in FIG. 17, when the core wires 2 are aligned by the global pitch alignment jig described in Patent Literature 1, tips of the plurality of core wires 2 are aligned along a substantially arcked track by which the tip of the central core wire 2C protrudes most. In the case where such a plurality of core wires 2 are cut along a straight cutting line CL in FIG. 17 (hereinafter, such an operation will be referred to also as “cutting along a straight line”) in order to crimp a terminal, the core wires 2 have different lengths although the terminal may be crimped. As shown in FIG. 17, the portion that is cut off from the central core wire 2C is longer than the portion that is cut off from the end core wire 2R. The difference in the length among the plurality of core wires 2 may possibly cause a problem.

The present invention, made in light of such a point, has an object of providing a core wire alignment apparatus capable of aligning a plurality of core wires of a multi-core cable such that positions of tips of the aligned core wires are flush with each other.

### Solution to Problem

A core wire alignment apparatus for a multi-core cable according to the present invention includes a first grip member, a first driving portion, an alignment member, a second driving portion, a bending device, and a controller. The first grip member is a member gripping the multi-core cable including a plurality of core wires and a sheath. Tips of the plurality of core wires are exposed from the sheath. The first grip member grips the multi-core cable such that the plurality of exposed core wires are directed in a predetermined tip direction. The first driving portion drives the first grip member to grip the multi-core cable. The alignment member includes a plurality of comb teeth and is provided to the front of the first grip member in the tip direction. The second driving portion moves at least one of the first grip member and the alignment member such that the plurality of comb teeth are inserted between the plurality of core wires. The bending device forms bent portions protruding in a crossing direction crossing the tip direction, the bent portions being formed between portions of the core wires that are gripped by the first grip member and portions of the core wires into which the comb teeth are inserted. The controller controls the first driving portion, the second driving portion and the bending device. The controller performs a grip control, a bending control, and an alignment control. The grip control is a control of controlling the first driving portion to cause the first grip member to grip the multi-core cable. The bending control is a control of controlling the bending device to form each of the bent portions in each of the plurality of core wires. The alignment control is performed after the grip control and the bending control. The alignment control is a control of controlling the second driving portion to insert the plurality of comb teeth between the plurality of core wires.

With the above-described core wire alignment apparatus for the multi-core cable, even when each of the core wires is pulled by the alignment member in the alignment control, the bent portion formed in each of the core wires is deformed and thus the position of the tip of each of the core wires is not easily moved. Therefore, the positions of the tips of the aligned core wires may be flush with each other.

According to a preferred embodiment of the core wire alignment apparatus of the present invention, the bending device includes a first bending member including a protruding portion protruding in the crossing direction, a second bending member including a receiving portion to which the protruding portion is fittable, and a third driving portion moving at least the first bending member in the crossing direction to cause the first bending member and the second bending member to be closer to each other. The first bending member and the second bending member are provided such that the protruding portion and the receiving portion face each other across the multi-core cable in a state of gripped by the first grip member. In the bending control, the controller drives the third driving portion to cause the first bending member and the second bending member to be closer to each other and to sandwich the plurality of core wires by use of the protruding portion and the receiving portion, thus to form the bent portion in each of the plurality of core wires.

With the above-described core wire alignment apparatus for the multi-core cable, the bent portions are formed by the protruding portion and the receiving portion sandwiching the core wires. Therefore, the dispersion in the position and the shape of the bent portions may be suppressed.

According to a preferred embodiment of the above-described core wire alignment apparatus, the first bending member includes a main body capable of accommodating the protruding portion or causing the protruding portion to protrude therefrom. The core wire alignment apparatus further includes a fourth driving portion causing the protruding portion to be accommodated in the main body or to protrude from the main body, and a moving device moving the first bending member and the second bending member in the tip direction with respect to the first grip member. In a state where the protruding portion is accommodated in the main body, the first bending member and the second bending member are capable of sandwiching the plurality of core wires of the multi-core cable in a state of being gripped by the first grip member. The controller performs, before the bending control, a straightening control of causing the first bending member in a state of accommodating the protruding portion and the second bending member to be closer to each other and to sandwich the plurality of core wires, and also of controlling the moving device to move the first bending member and the second bending member in the tip direction. In addition, the controller controls the fourth driving portion to cause the protruding portion to protrude after the straightening control but before the bending control.

With the above-described core wire alignment apparatus for the multi-core cable, the straightening control is performed before the alignment control, so that the plurality of core wires may be aligned preliminarily and extended straight. This allows the plurality of core wires to be inserted into the alignment member easily. In addition, the straightening control may be performed by use of the first bending member and the second bending member, which are usable to form the bent portions. Therefore, the number of the components of the core wire alignment apparatus may be decreased.

According to a preferred embodiment of the above-described core wire alignment apparatus, the first bending member includes a plurality of first grooves formed therein, the plurality of first grooves corresponding to the plurality of core wires and being aligned in a perpendicular direction perpendicular to the tip direction. The first bending member contacts the plurality of core wires at the plurality of first grooves when sandwiching the plurality of core wires together with the second bending member. According to another preferred embodiment of the above-described core wire alignment apparatus, the second bending member includes a plurality of second grooves formed therein, the plurality of second grooves corresponding to the plurality of core wires and being aligned in the perpendicular direction perpendicular to the tip direction. The second bending member contacts the plurality of core wires at the plurality of second grooves when sandwiching the plurality of core wires together with the first bending member.

With the core wire alignment apparatus for the multi-core cable according to the embodiment described above, the core wires may be aligned in the perpendicular direction by the first grooves preliminarily before the alignment control. This allows the plurality of core wires to be inserted into the alignment member more easily. With the core wire alignment apparatus for the multi-core cable according to the another embodiment described above, the core wires may be aligned in the perpendicular direction by the second grooves preliminarily before the alignment control. The core wire alignment apparatus may include both of the first grooves and the second grooves, or may include one of the first grooves and the second grooves.

According to a preferred embodiment of the core wire alignment apparatus of the embodiment described above, the first bending member includes a first roller including the plurality of first grooves formed therein, the first roller being rotatable about an axis extending in the perpendicular direction. According to a preferred embodiment of the core wire alignment apparatus of the another embodiment described above, the second bending member includes a second roller including the plurality of second grooves formed therein, the second roller being rotatable about an axis extending in the perpendicular direction.

With each of these core wire alignment apparatuses for the multi-core cable, the first roller or the second roller is rotated in the straightening control, and therefore, the first bending member and the second bending member may be moved smoothly.

According to a preferred embodiment of the core wire alignment apparatus of the present invention, the core wire alignment apparatus may further include a second grip member provided to the front of, in the tip direction, the protruding portion and the receiving portion in a state of forming the bent portion, and capable of gripping the plurality of core wires, and a fifth driving portion driving the second grip member to grip the plurality of core wires. In the bending control, the controller controls the fifth driving portion to cause the second grip member to grip the plurality of core wires, and controls the first driving portion to cause the first grip member to release the multi-core cable. In addition, the controller performs the grip control after the bending control, and in the grip control, controls the first driving portion to cause the first grip member to grip the multi-core cable and controls the fifth driving portion to cause the second grip member to release the plurality of core wires.

With the above-described core wire alignment apparatus for the multi-core cable, the core wires are gripped by the second clamp located to the front of the bent portions in the tip direction in the bending control, and therefore, the tips of the core wires are not moved even though the bent portions are formed. This allows the positions of the tips of the plurality of core wires to be flush with each other more precisely after the bending control.

According to a preferred embodiment of the above-described core wire alignment apparatus, the second grip member includes a first arm located to the front of the plurality of core wires in a moving direction of the alignment member in the alignment control, and a second arm located to the rear of the plurality of core wires in the moving direction of the alignment member in the alignment control. In the alignment control, the first arm supports the plurality of core wires.

With the above-described core wire alignment apparatus for the multi-core cable, in the alignment control, the first arm located to the front of the core wires in the moving direction of the alignment member supports the core wires, and therefore, escape of the core wires due to the insertion of the alignment member in the alignment control is suppressed. This allows the alignment of the core wires to be performed more certainly.

According to a preferred embodiment of the core wire alignment apparatus of the present invention, the bending device includes a second grip member provided to the front of the first grip member in the tip direction and capable of gripping the plurality of core wires, another driving portion driving the second grip member to grip the plurality of core wires, and an actuator causing the first grip member and the second grip member to be closer to each other. In the bending control, the controller controls the first driving portion to cause the first grip member to grip the multi-core cable, controls the another driving portion to cause the second grip member to grip the plurality of core wires, and controls the actuator to cause the first grip member and the second grip member to be closer to each other, thus to form the bent portion in each of the plurality of core wires.

With the above-described core wire alignment apparatus for the multi-core cable, the first grip member and the second grip member are caused to closer to each other to bend the core wires, so that the bent portions may be formed.

According to a preferred embodiment of the core wire alignment apparatus of the present invention, the core wire alignment apparatus further includes a sandwich member capable of sandwiching the plurality of core wires in a state where the multi-core cable is gripped by the first grip member, a sandwich device driving the sandwich member to grip the plurality of core wires, and a moving device moving the sandwich member in the tip direction with respect to the first grip member. The controller performs, before the bending control, a straightening control of controlling the sandwich device to cause the sandwich member to sandwich the plurality of core wires, and also controlling the moving device to move the sandwich member in the tip direction.

The straightening control may be performed also by the above-described core wire alignment apparatus for the multi-core cable.

According to a preferred embodiment of the core wire alignment apparatus of the present invention, where a direction, of the moving direction of the alignment member, in which the plurality of comb teeth are separated away from the plurality of core wires is a separation direction, the plurality of comb teeth have a plurality of gaps formed therebetween, the plurality of gaps respectively holding the plurality of core wires, and expand in the separation direction such that the plurality of gaps are farther from each other as extending in the separation direction.

With the above-described core wire alignment apparatus for the multi-core cable, the plurality of core wires are respectively inserted into the plurality of gaps, so that the interval between the plurality of aligned core wires may be a desired interval that is wider than the interval between the core wires before the core wires are aligned.

### Advantageous Effects of Invention

A core wire alignment apparatus for a multi-core cable according to the present invention allows positions of tips of aligned core wires to be flush with each other.

### BRIEF DESCRIPTION OF DRAWINGS

FIG. 1 is a perspective view of a core wire alignment apparatus for a multi-core cable.

FIG. 2 is a rear view of the core wire alignment apparatus.

FIG. 3 is a side view of the core wire alignment apparatus in a state where a bending device has been advanced and is opened.

FIG. 4 is a side view of the core wire alignment apparatus in a state where the bending device sandwiches the multi-core cable in a straightening control.

FIG. 5 is a rear view of a first alignment roller and a second alignment roller.

FIG. 6 is a side view of the core wire alignment apparatus in a state where the bending device has been advanced in the straightening control.

FIG. 7 is a side view of the core wire alignment apparatus in a state where the bending device is opened and a protruding portion protrudes therefrom.

FIG. 8 is a rear view of the core wire alignment apparatus in a state where a second grip device grips core wires.

FIG. 9 is a side view of the core wire alignment apparatus during formation of a bent portion.

FIG. 10 is a side view of the core wire alignment apparatus after the bent portion is formed.

FIG. 11 is a rear view of an alignment member.

FIG. 12 is side view of the core wire alignment apparatus in a state where the alignment member has been moved downward.

FIG. 13 is a rear view of the alignment member in a state where the core wires are aligned.

FIG. 14 is a plan view of the multi-core cable in a state where the core wires are aligned.

FIG. 15 is a side view of the core wire alignment apparatus in a state where the alignment member has been retracted.

FIG. 16 is a block diagram of the core wire alignment apparatus.

FIG. 17 is a plan view of a multi-core cable in a state where the core wires are aligned by a conventional method.

### DESCRIPTION OF EMBODIMENTS

### [Configuration of the Apparatus]

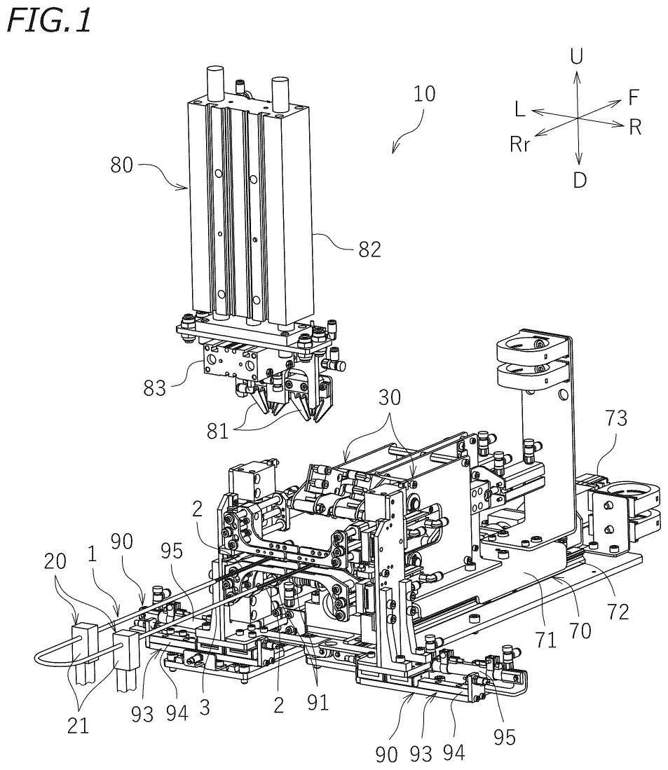

Hereinafter, an embodiment of the present invention will be described. FIG. 1 is a perspective view of a core wire alignment apparatus 10 for a multi-core cable 1 according to an embodiment. An electric cable to be processed by the core wire alignment apparatus 10 is the multi-core cable 1 including a plurality of core wires 2 having tips thereof exposed from a sheath 3. Hereinafter, unless otherwise specified, the term “core wires 2” refers to core wires exposed from the sheath 3. Before being mounted on the core wire alignment apparatus 10, the multi-core cable 1 is subjected to a process of peeling off the sheath 3 at an end thereof, a process of untwisting the plurality of core wires 2 in a twisted state, and the like. In this embodiment, the multi-core cable 1 includes five core wires 2. It should be noted that there is no specific limitation on the number of the core wires 2 included in the multi-core cable 1. The plurality of core wires 2 may be all core wirings or may include drain wirings connected with a shield. In the case where the plurality of core wires 2 include drain wirings, it is preferred that the drain wirings are insulated.

The core wire alignment apparatus 10 according to this embodiment aligns both of two ends of the five core wires 2, that is, ten ends in total of the core wires 2. The multi-core cable 1 is bent into a U shape for this purpose, and the all the ends of the core wires 2 of the multi-core cable 1 are directed in the same direction. Hereinafter, a direction in which the plurality of exposed core wires 2 are directed will be referred to also as a “forward direction” or a “tip direction” of the multi-core cable 1 or the core wires 2. “Leftward” and “rightward” are leftward and rightward as seen from a person directed forward. In the drawings, letters F, Rr, L, R, U and D respectively indicate front, rear, left, right, up and down. It should be noted that these directions are provided merely for the convenience of the description, and do not limit the manner of installation or the like of the core wire alignment apparatus 10 in any way. In the drawings, some of components of the core wire alignment apparatus 10 may be omitted or simplified for the reasons regarding illustration by the drawings or description.

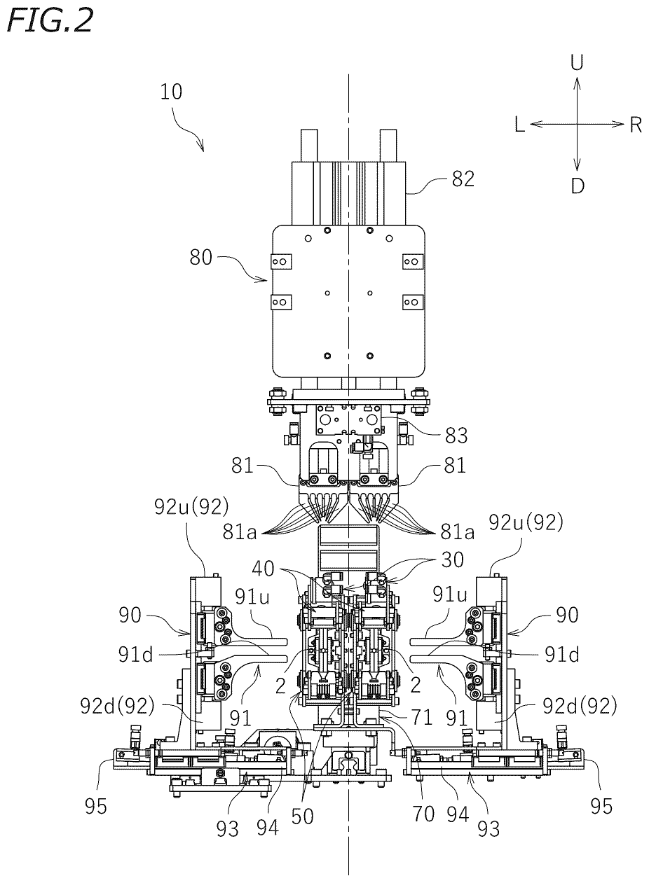

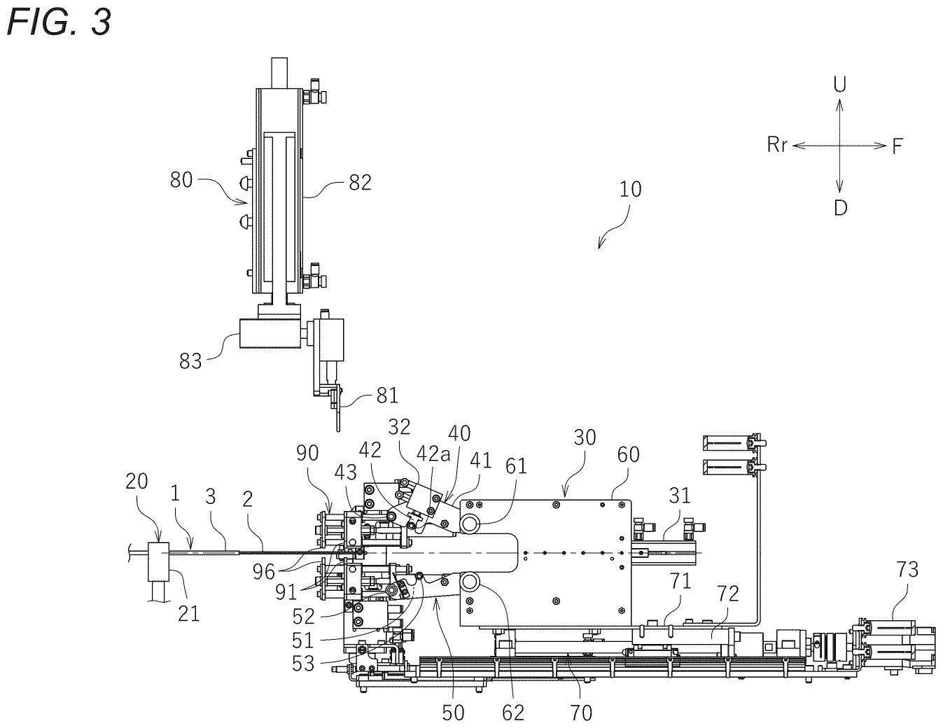

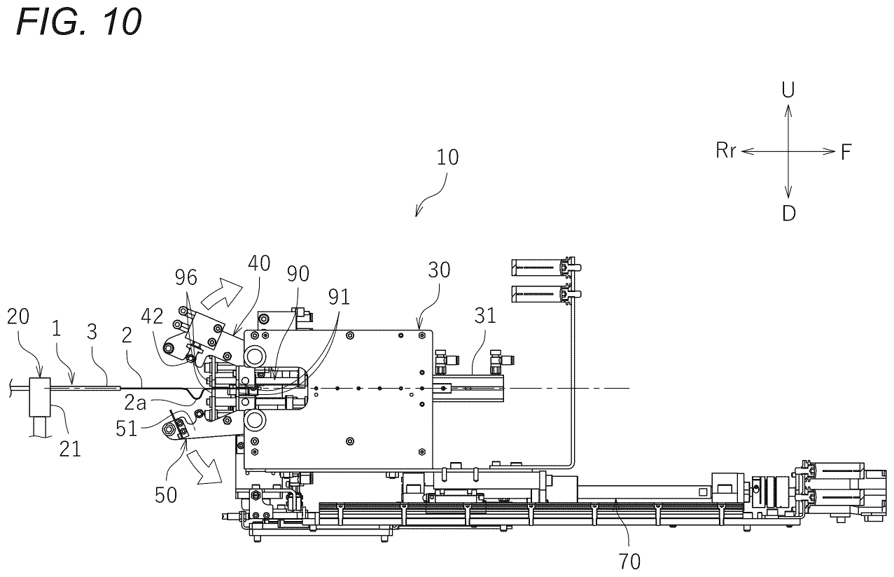

FIG. 2 is a rear view of the core wire alignment apparatus 10. FIG. 3 is a right side view of the core wire alignment apparatus 10. As shown in FIG. 1 through FIG. 3, the core wire alignment apparatus 10 according to this embodiment includes first grip devices 20, bending devices 30, a moving device 70, an alignment device 80, and second grip devices 90. The first grip devices 20 grip the multi-core cable 1 such that the plurality of exposed core wires 2 are directed forward. The bending devices 30 each form a bent portion 2a (see FIG. 10) in each of the plurality of core wires 2 such that the plurality of core wires 2 have a margin for pulling. Hereinafter, the formation of the bent portion 2a will be referred to also as “shaping”. The moving device 70 moves the bending device 30 in a front-rear direction. The alignment device 80 aligns the plurality of core wires 2 in a left-right direction at a predetermined interval. The second grip devices 90 grip the core wires 2 at least at the time of the shaping.

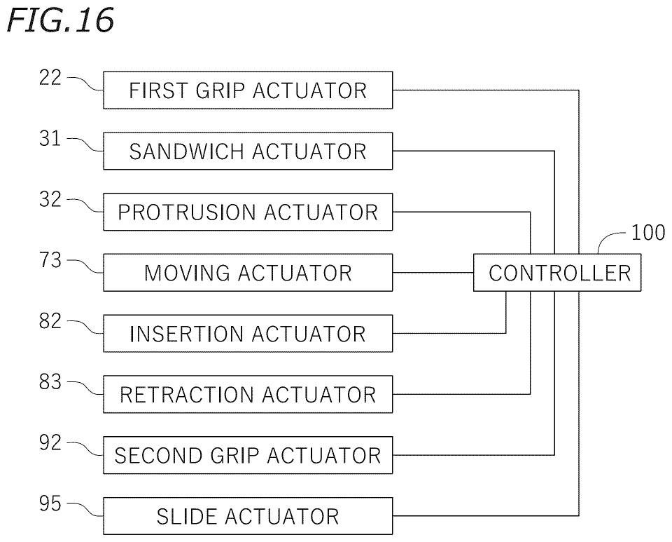

The first grip devices 20 are located at a rearmost position in the core wire alignment apparatus 10. As shown in FIG. 3, the first grip devices 20 each include a first clamp 21 gripping the multi-core cable 1 such that the plurality of exposed core wires 2 are directed forward, and a first grip actuator 22 (see FIG. 16) driving the first clamp 21 to grip the multi-core cable 1. In this embodiment, the first grip actuator 22 is air-driven. It should be noted the first grip actuator 22 is not limited to being of this type. The first grip actuator 22 may be, for example, an electric actuator. The first grip devices 20 hold the multi-core cable 1 such that the plurality of core wires 2 are aligned in the left-right direction on a horizontal plane. The first grip devices 20 may each have a rotation mechanism that rotates the multi-core cable 1 in a circumferential direction such that the plurality of core wires 2 are aligned in the left-right direction on the horizontal plane.

The bending devices 30 each forms the bent portion 2a in each of the plurality of core wires 2. In this embodiment, each of the bending devices 30 bends the plurality of core wires 2 to form the bent portions 2a protruding downward in the plurality of core wires 2 (see FIG. 10). The downward direction is one of directions that cross an axial direction of the plurality of core wires 2 in a state of being held by the first grip device 20 (the axial direction is the front-rear direction in this embodiment). The direction in which the core wires 2 are bent in order to form the bent portions 2a may be any direction crossing the axial direction of the core wires 2, and is not limited to the downward direction. As described below in detail, the bending device 30 forms the bent portions 2a in portions, of the core wires 2, between portions gripped by the first clamp 21 and portions between which comb teeth 81a (see FIG. 2) of the alignment device 80 are inserted. The bending device 30 is located to the front of the first grip device 20.

As shown in FIG. 3, the bending device 30 includes a first bending member 40, a second bending member 50, and a support member 60. The first bending member 40 and the second bending member 50 are provided to face each other across the multi-core cable 1 in a state of being gripped by the first clamps 21. In this embodiment, the first bending member 40 is located above the multi-core cable 1. The second bending member 50 is located below the multi-core cable 1. The support member 60 supports the first bending member 40 and the second bending member 50 such that the first bending member 40 and the second bending member 50 are pivotable in an up-down direction. The bending device 30 includes a sandwich actuator 31 moving at least the first bending member 40 downward to cause the first bending member 40 and the second bending member 50 to be closer to each other. In this embodiment, the sandwich actuator 31 pivots the first bending member 40 downward and pivots the second bending member 50 upward to cause the first bending member 40 and the second bending member 50 to be closer to each other. It should be noted that the second bending member 50 may be immovably secured to the support member 60 and the sandwich actuator 31 may move only the first bending member 40. In this embodiment, the sandwich actuator 31 is air-driven. It should be noted that there is no specific limitation on the type of the sandwich actuator 31.

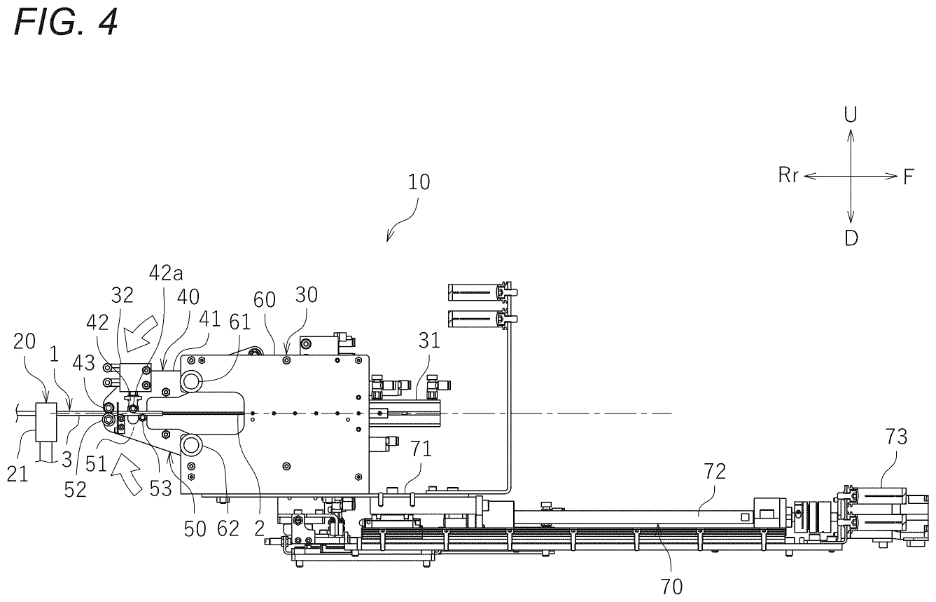

Hereinafter, a state where the first bending member 40 and the second bending member 50 sandwich the core wires 2 will be referred to also as a “state where the bending device 30 is closed”. A state where the first bending member 40 and the second bending member 50 are away from each other and do not sandwich the core wires 2 will be referred to also as a “state where the bending device 30 is opened”. FIG. 3 is a side view of the core wire alignment apparatus 10 in the state where the bending device 30 is opened. FIG. 4 is a side view of the core wire alignment apparatus 10 in the state where the bending device 30 is closed.

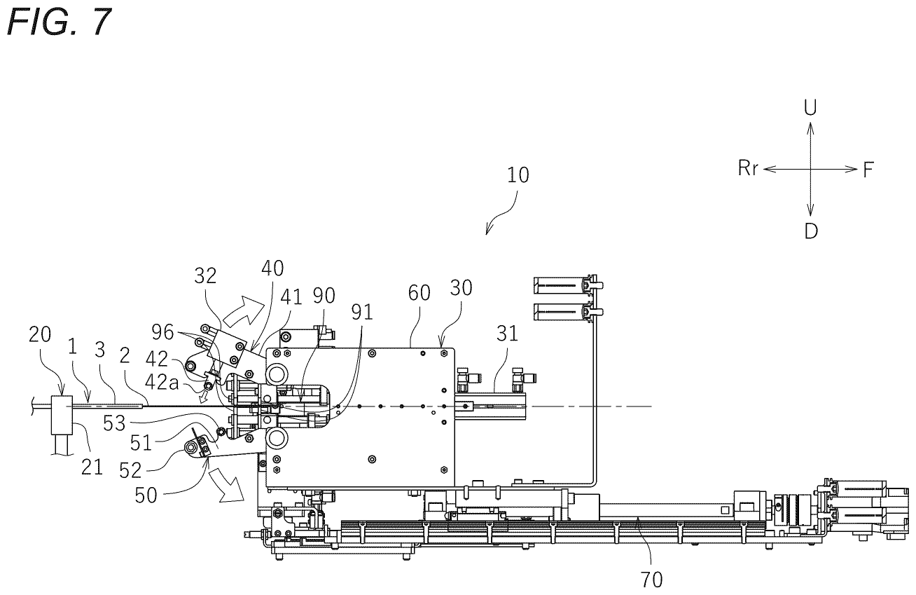

As shown in FIG. 3, the first bending member 40 includes a main body 41, a protruding portion 42 protruding downward (see FIG. 7), and a first alignment roller 43 provided at a rear end of the main body 41. In this embodiment, the protruding portion 42 is movable. The main body 41 is capable of accommodating the protruding portion 42 therein or allowing the protruding portion 42 to protrude therefrom. The bending device 30 includes a protrusion actuator 32 causing the protruding portion 42 to be accommodated in the main body 41 or to protrude from the main body 41. As shown in FIG. 3, the protruding portion 42, in a state of being accommodated in the main body 41, is flush with a bottom side of the main body 41 or slightly protrudes from the bottom side of the main body 41. As shown in FIG. 7, the protruding portion 42, in a state of protruding from the main body 41, protrudes to a position below the bottom surface of the main body 41. A tip roller 42a is provided at a bottom end of the protruding portion 42. The tip roller 42a has a rotation axis extending in the left-right direction, and is rotatable in the front-rear direction. The tip roller 42a is set to have a width in the left-right direction that is longer than that of the plurality of core wires 2 in a state of being aligned in the left-right direction. In this embodiment, the protrusion actuator 32 is an air cylinder. It should be noted that there is no specific limitation on the type of the protrusion actuator 32.

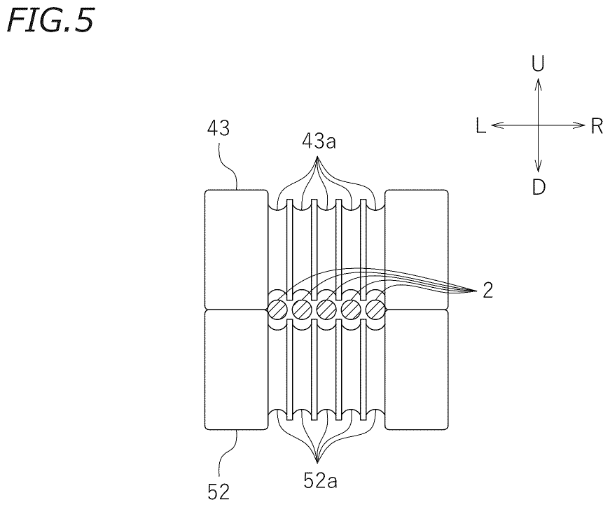

The first alignment roller 43 aligns the plurality of core wires 2 in the left-right direction preliminarily before the plurality of core wires 2 are aligned by the alignment device 80. The first alignment roller 43 is rotatable about an axis thereof extending in the left-right direction. FIG. 5 is a rear view of the first alignment roller 43 and a second alignment roller 52 described below. As shown in FIG. 5, the first alignment roller 43 includes a plurality of first grooves 43a formed therein. The plurality of first grooves 43a are aligned in the left-right direction. The left-right direction is perpendicular to the front-rear direction, which is the axial direction of the plurality of core wires 2. The left-right direction is also a direction in which the core wires 2 are aligned. The plurality of first grooves 43a respectively correspond to the plurality of core wires 2. The plurality of first grooves 43a are each a semicylindrical groove having a diameter corresponding to that of each of the core wires 2. The number of the first grooves 43a is the same as the number of the core wires 2. The first grooves 43a are formed around the entirety of a circumference of the first alignment roller 43 rotatable in the front-rear direction. The tip roller 42a of the protruding portion 42 may include a plurality of grooves substantially the same as the first grooves 43a. Alternatively, the first bending member 40 does not need to include the first alignment roller 43, and the plurality of first grooves 43a may be formed in, for example, a bottom surface of the main body 41.

As shown in FIG. 3, the second bending member 50 includes a second alignment roller 52 and a front roller 53. The second alignment roller 52 is provided at a rear end of the second bending member 50, and faces the first alignment roller 43 in the up-down direction. As shown in FIG. 5, the second alignment roller 52 has substantially the same configuration as that of the first alignment roller 43, and includes a plurality of second grooves 52a formed therein. In the state where the bending device 30 is closed, the second grooves 52a face the plurality of first grooves 43a. The second alignment roller 52 is rotatable about an axis thereof extending in the left-right direction. The plurality of second grooves 52a are each a semicylindrical groove having a diameter corresponding to that of each of the core wires 2. The number of the second grooves 52a is the same as the number of the core wires 2. The plurality of second grooves 52a respectively correspond to the plurality of core wires 2. The second bending member 50 may include the plurality of second grooves 52a in a top surface thereof, instead of including the second alignment roller 52. The front roller 53 is provided to the front of the second alignment roller 52. The front roller 53 is also rotatable in the front-rear direction, and may include a plurality of grooves substantially the same as the second grooves 52a.

The second alignment roller 52 and the front roller 53 form a receiving portion 51 corresponding to the protruding portion 42 of the first bending member 40. When the bending device 30 is closed in a state where the protruding portion 42 protrudes, the protruding portion 42 is fitted into the receiving portion 51. As shown in FIG. 7, the receiving portion 51 and the protruding portion 42 of the first bending member 40 face each other in the up-down direction across the multi-core cable 1 in a state of being gripped by the first clamp 21. When the bending device 30 is closed in a state where the protruding portion 42 protrudes, the protruding portion 42 is accommodated between the second alignment roller 52 and the front roller 53. The first bending member 40 and the second bending member 50 are driven by the sandwich actuator 31 to get close to each other and thus the plurality of core wires 2 are sandwiched between the protruding portion 42 and the receiving portion 51, so that the bent portions 2a are formed. In more detail, in a state where the plurality of core wires 2 are supported by the second alignment roller 52 and the front roller 53 forming the receiving portion 51, the protruding portion 42 pushes the plurality of core wires 2 into a space between the second alignment roller 52 and the front roller 53, so that the bent portions 2a are formed.

Even in a state where the protruding portion 42 is accommodated in the main body 41, the first bending member 40 and the second bending member 50 are capable of sandwiching the plurality of core wires 2 of the multi-core cable 1 in a state of being gripped by the first clamps 21. In more detail, as shown in FIG. 4, the first bending member 40 and the second bending member 50 sandwich the plurality of core wires 2 by use of the first alignment roller 43 and the second alignment roller 52. When sandwiching the plurality of core wires 2, the first bending member 40 and the second bending member 50 contact the plurality of core wires 2 respectively at the plurality of first grooves 43a and the plurality of second grooves 52a.

The support member 60 includes a first pivoting shaft 61 supporting the first bending member 40 such that the first bending member 40 is pivotable, and a second pivoting shaft 62 supporting the second bending member 50 such that the second bending member 50 is pivotable. The first bending member 40 and the second bending member 50 are respectively pivoted about the first pivoting shaft 61 and the second pivoting shaft 62 to get close to, or farther from, each other.

The moving device 70 moves the first bending member 40 and the second bending member 50 in the front-rear direction via the support member 60. FIG. 3 shows the core wire alignment apparatus 10 in a state where the bending device 30 is at a frontmost position thereof. FIG. 4 shows the core wire alignment apparatus 10 in a state where the bending device 30 is at a rearmost position thereof. In this embodiment, the moving device 70 supports the support member 60 such that the support member 60 is movable in the front-rear direction. As shown in FIG. 3, the moving device 70 includes a holding table 71, a guide rail 72, and a moving actuator 73. The holding table 71 is provided below the support member 60, which supports the bending device 30, and supports the support member 60. The holding table 71 is in slidable engagement with the guide rail 72. The guide rail 72 extends in the front-rear direction. The holding table 71 is movable in the front-rear direction along the guide rail 72. The moving actuator 73 is a driving portion that moves the holding table 71 along the guide rail 72. In this embodiment, the moving actuator 73 is also an air cylinder. It should be noted that there is no specific limitation on the type of the moving actuator 73.

As shown in FIG. 1 and FIG. 2, a pair of, more specifically, left and right, first grip devices 20, and a pair of, more specifically, left and right, bending devices 30 are provided in order to process both of two ends of the multi-core cable 1 bent in a U shape. The moving device 70 moves the pair of bending devices 30 at the same time. The pair of bending devices 30 are both provided on the holding table 71. A pair of, more specifically, left and right, second grip devices 90 are provided for substantially the same reason. It should be noted that the core wire alignment apparatus 10 may process one end of the multi-core cable 1. In this case, the core wire alignment apparatus 10 may include one first grip device 20, one bending device 30 and one second grip device 90.

As shown in FIG. 2, the alignment device 80 is provided above the bending devices 30. The alignment device 80 includes a pair of, more specifically, left and right, alignment members 81 aligning the plurality of core wires 2, an insertion actuator 82 moving the pair of alignment members 81 in the up-down direction, and a retraction actuator 83 moving the pair of alignment members 81 in the front-rear direction. The insertion actuator 82 and the retraction actuator 83 are both air cylinders in this embodiment, but are not limited thereto. As shown in FIG. 2, the alignment members 81 are each a flat plate-like member extending in the left-right direction and the up-down direction. The position of the alignment members 81 in the left-right direction overlaps the position of the core wires 2 of the multi-core cable 1 in a state of being held by the first grip devices 20. As shown in FIG. 3, the alignment members 81 are each provided closer to the tip of the multi-core cable 1 than the first clamp 21, that is, to the front of the first clamp 21 in this embodiment.

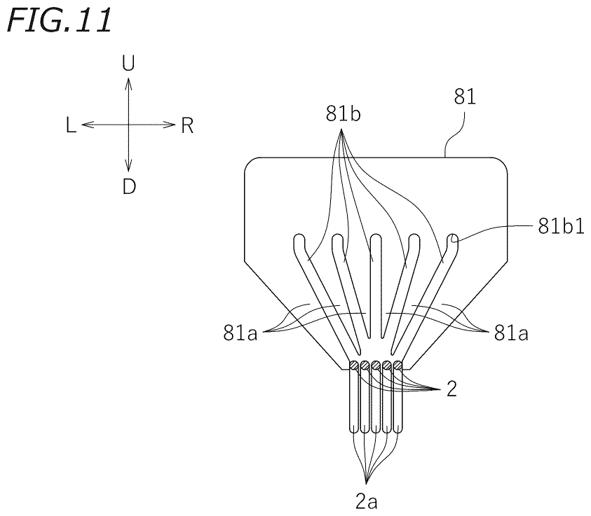

FIG. 11 is a rear view of the alignment member 81. As shown in FIG. 11, the alignment member 81 includes the plurality of comb teeth 81a, between which the plurality of core wires 2 are inserted. The plurality of comb teeth 81a are aligned in the alignment direction in which the core wires 2 are aligned, that is, in the left-right direction in this embodiment. The plurality of comb teeth 81a have a plurality of gaps 81b formed therebetween, in which the plurality of core wires 2 may be held respectively. The insertion actuator 82 moves the alignment member 81 such that the plurality of comb teeth 81a are inserted between the plurality of core wires 2. As shown in FIG. 11, at a bottom end of the alignment member 81, the plurality of gaps 81b are aligned at an interval substantially the same as that of the plurality of core wires 2 aligned by the first alignment roller 43 and the second alignment roller 52. When the alignment member 81 is moved downward and contacts the plurality of core wires 2, the plurality of core wires 2 are respectively inserted into the plurality of gaps 81b.

The plurality of comb teeth 81a expand upward such that the plurality of gaps 81b are farther from each other as extending upward. The upward direction is the direction, among the moving directions in which the alignment member 81 is movable, in which the plurality of comb teeth 81a get farther from the plurality of core wires 2. When the bottom end of the alignment member 81 contacts the plurality of core wires 2 and then the alignment member 81 moves further downward, the plurality of core wires 2 move so as to expand in the left-right direction along the gaps 81b. The insertion actuator 82 is configured to stop the alignment member 81 at a position in the up-down direction where the core wires 2 reach top ends 81b1 of the gaps 81b. Such a position of the alignment member 81 may correspond to a stroke end of the insertion actuator 82. It should be noted that the insertion actuator 82 may be controlled to stop the alignment member 81 at the above-mentioned position.

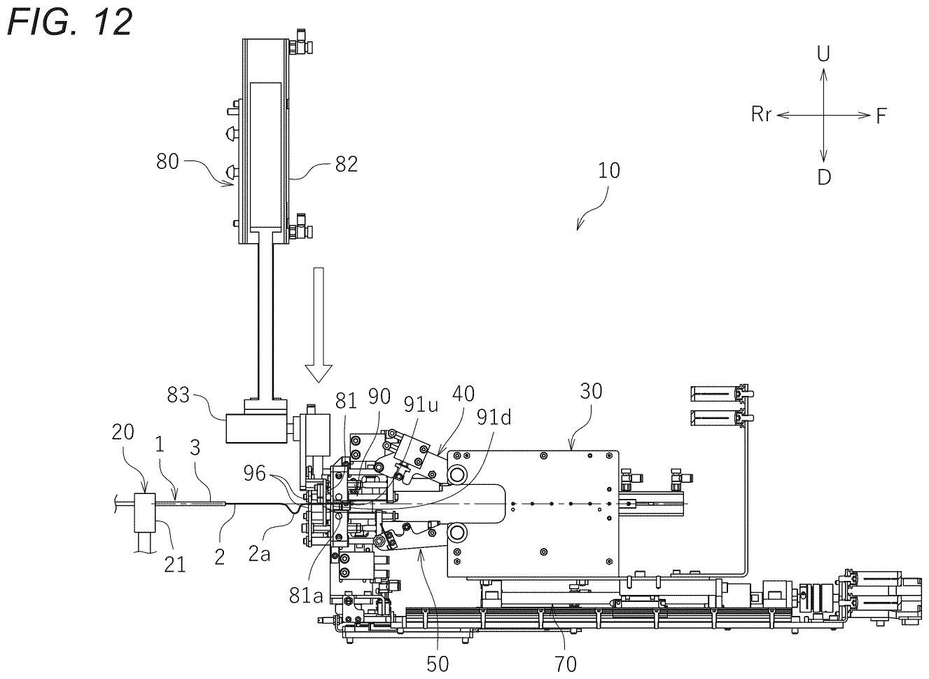

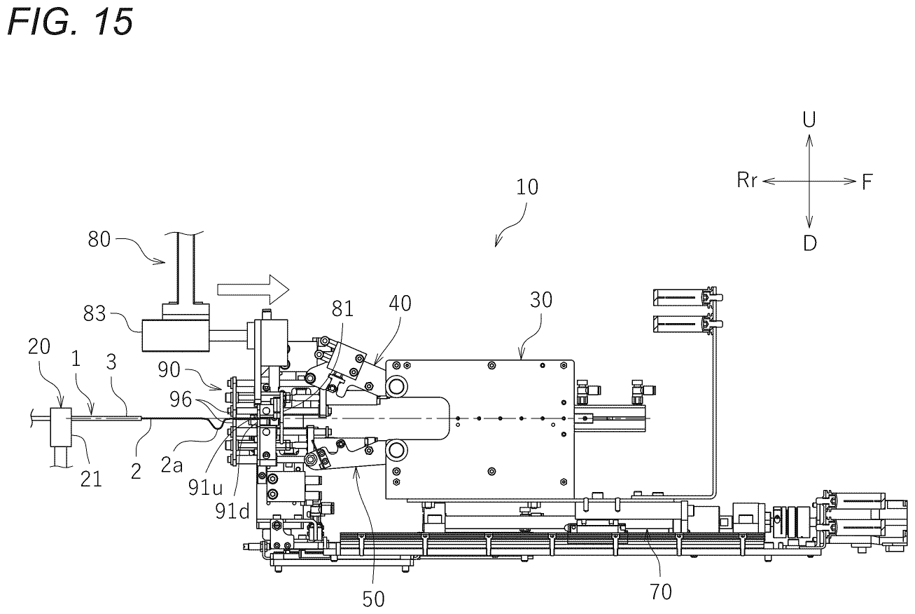

FIG. 12 is a side view of the core wire alignment apparatus 10 in a state where the alignment members 81 have been moved downward. As shown in FIG. 12, the alignment members 81 are inserted into the plurality of core wires 2 at a position to the front of the bent portions 2a. As shown in FIG. 15, the retraction actuator 83 retracts the pair of alignment members 81 further to a position to the front of the tips of the plurality of core wires 2.

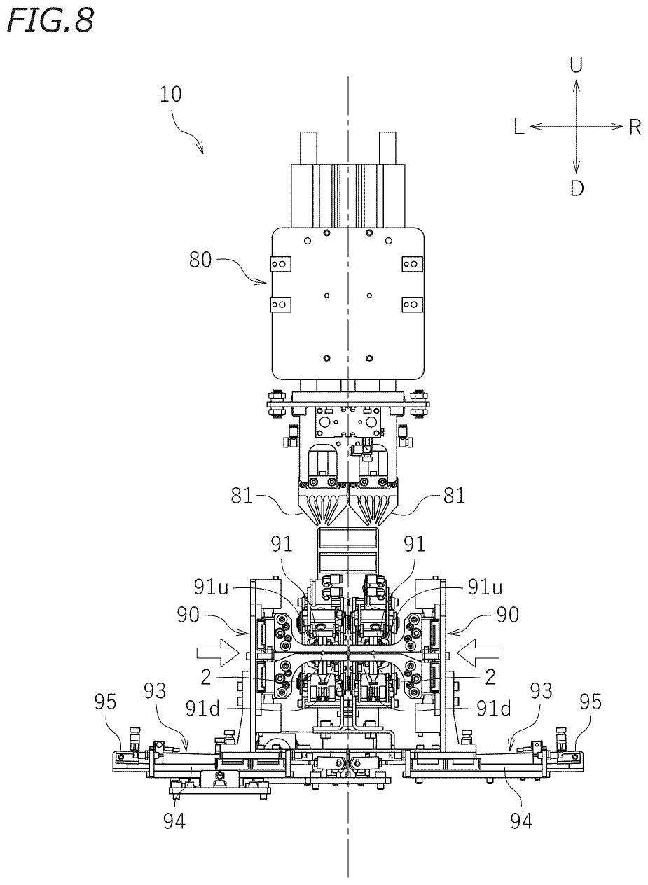

The second grip devices 90 are each capable of gripping the core wires 2. As shown in FIG. 2, the second grip devices 90 each include a second clamp 91 capable of gripping the plurality of core wires 2, a second grip actuator 92 driving the second clamp 91 to grip the plurality of core wires 2, a slide mechanism 93, and a core wire restriction portion 96 (see FIG. 3). The slide mechanism 93 moves the second clamp 91 in the left-right direction. The slide mechanism 93 includes a guide rail 94 and a slide actuator 95. The second clamp 91 is in slidable engagement with the guide rail 94. The guide rail 94 extends in the left-right direction. The second clamp 91 is movable in the left-right direction along the guide rail 94. The slide actuator 95 is a driving portion that moves the second clamp 91 along the guide rail 94. The slide actuator 95 is also an air cylinder in this embodiment, but there is no specific limitation on the type of the slide actuator 95. FIG. 2 shows a state where the second clamp 91 is located outer to the multi-core cable 1 in the left-right direction. FIG. 8 shows a state where the second clamp 91 has been moved inward in the left-right direction so as to be capable of gripping the core wires 2.

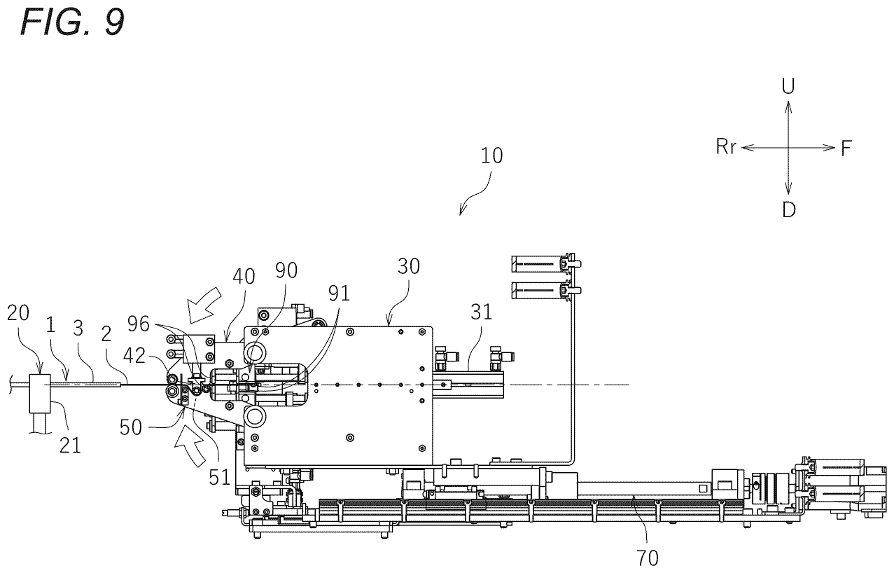

As shown in FIG. 2, the second clamps 91 each include a pair of, more specifically, bottom and top arms 91d and 91u. The second clamp 91 grips the core wires 2 by sandwiching the core wires 2 by use of the bottom arm 91d and the top arm 91u. The bottom arm 91d is movable in the up-down direction by a bottom second grip actuator 92d. The top arm 91u is movable in the up-down direction by a top second grip actuator 92u. FIG. 9 is a side view of the core wire alignment apparatus 10 during the formation of the bent portion 2a (see FIG. 10), although a process for forming the bent portion 2a will be described below. As shown in FIG. 9, the second clamp 91 is provided to the front of the protruding portion 42 and the receiving portion 51 in a state of forming the bent portion 2a. As shown in FIG. 9, in this embodiment, while the bent portion 2a is being formed, the bending device 30 is retracted from, for example, the state in FIG. 3. For example, in the state in FIG. 3, the second clamp 91 is located to the rear of the protruding portion 42 and the receiving portion 51. It should be noted that the second clamp 91 may be always provided to the front of the protruding portion 42 and the receiving portion 51. As shown in FIG. 12, the second clamp 91 grips portions of the core wires 2 that are to the front of the alignment member 81 in a state of being inserted into the core wires 2.

The core wire restriction portion 96 is provided to the rear of the second clamp 91, and is movable in the left-right direction and in the front-rear direction together with the second clamp 91. A pair of, more specifically, top and bottom, core wire restriction portions 96 are provided. While the second clamps 91 grip the plurality of core wires 2, the core wire restriction portions 96 are slightly distanced away from the plurality of core wires 2. As shown in FIG. 12, the core wire restriction portions 96 are each provided between the bent portions 2a and the alignment member 81 in the front-rear direction.

FIG. 16 is a block diagram of the core wire alignment apparatus 10. As shown in FIG. 16, the core wire alignment apparatus 10 includes a controller 100 controlling the first grip actuators 22 of the first grip devices 20, the sandwich actuators 31 and the protrusion actuators 32 of the bending devices 30, the moving actuator 73 of the moving device 70, the insertion actuator 82 and the retraction actuator 83 of the alignment device 80, and the second grip actuators 92 and the slide actuators 95 of the second grip devices 90. The controller 100 is connected to the above-listed actuators and controls operations thereof. There is no specific limitation on the configuration of the controller 100. The controller 100 may include, for example, a central processing unit (hereinafter, referred to as a “CPU”), a ROM storing programs and the like executable by the CPU, a RAM and the like. Each of the components of the controller 100 may be formed of software or hardware. Each of the components may be a processor or a circuit. The controller 100 may be, for example, a programmable controller, a computer or the like.

### [Process for Aligning the Core Wires]

Hereinafter, a process for aligning the core wires 2 by the core wire alignment apparatus 10 according to this embodiment will be described. At the start of the process, the core wire alignment apparatus 10 is in the state shown in FIG. 2 and FIG. 3. That is, each of the bending devices 30 has been advanced and is opened. Each of the protruding portions 42 is accommodated in the main body 41. Each of the second clamps 91 is retracted at an outer position. Each of the alignment members 81 is retracted and is located above the core wires 2. Each of the first clamps 21 grips the multi-core cable 1 such that the plurality of core wires 2 are aligned in the left-right direction. In the process for aligning the core wires 2, the controller 100 performs roughly four stages of control, that is, a straightening control, a bending control, a grip control, and an alignment control. The bending control is performed after the straightening control, and the grip control is performed after the straightening control. The alignment control is performed after the grip control.

First, the straightening control will be described. In the straightening control, the first alignment roller 43 and the second alignment roller 52 are used to align the plurality of core wires 2 at a narrow interval and to extend the core wires 2 straight. In the straightening control, the controller 100 causes the first bending member 40 in a state of accommodating the protruding portion 42 and the second bending member 50 to be closer to each other and to sandwich the plurality of core wires 2, and also controls the moving device 70 to move the first bending member 40 and the second bending member 50 forward.

This will be described in more detail. In the straightening control, the controller 100 first controls the moving device 70 to retract the bending device 30. In the next step, the controller 100 controls the sandwich actuator 31 to close the bending device 30. As a result, the core wire alignment apparatus 10 is put into the state shown in FIG. 4. As shown in FIG. 4, at this point, the first bending member 40 and the second bending member 50 sandwich the sheath 3 of the multi-core cable 1. At this point, the first bending member 40 and the second bending member 50 sandwich the sheath 3 of the multi-core cable 1 by use of the first alignment roller 43 and the second alignment roller 52.

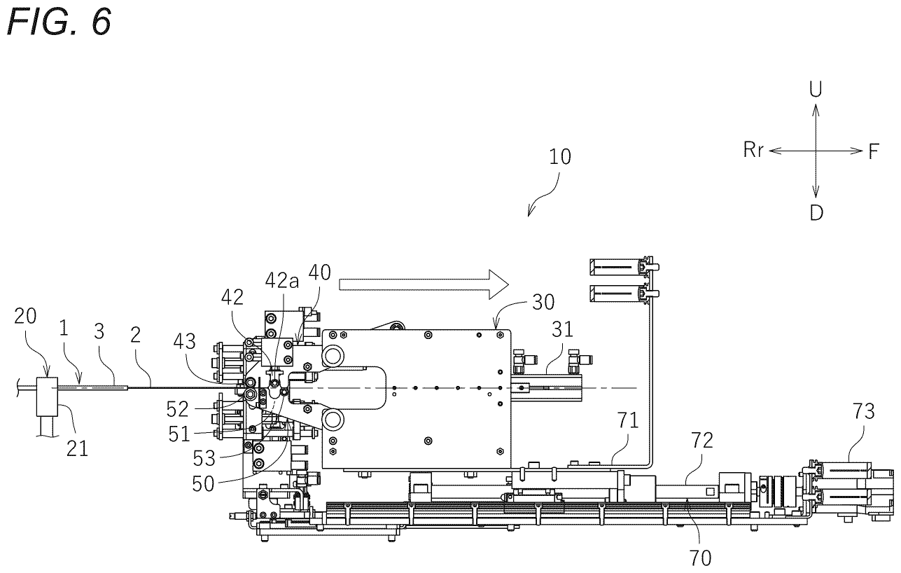

Next, the controller 100 controls the moving device 70 to move the bending device 30 forward. As a result, as shown in FIG. 5, each of the core wires 2 is inserted between a corresponding first groove 43a of the first alignment roller 43 and a corresponding second groove 52a of the second alignment roller 52. In this manner, the plurality of core wires 2 are aligned in the left-right direction at a narrow pitch corresponding to the pitch of the first grooves 43a and the pitch of the second grooves 52a, and are also extended straight. The first alignment roller 43 and the second alignment roller 52 are rotated, so that the bending device 30 moves forward smoothly. FIG. 6 shows the core wire alignment apparatus 10 in a state where the bending device 30 has been advanced in the straightening control.

After the straightening control but before the bending control, the controller 100 controls the protrusion actuator 32 to cause the protruding portion 42 to protrude. In more detail, as shown in FIG. 7, the controller 100 controls the sandwich actuator 31 to open the bending device 30 and controls the protrusion actuator 32 to cause the protruding portion 42 to protrude from the main body 41.

Now, the bending control will be described. The bending control is to control the bending device 30 to form the bent portion 2a in each of the plurality of core wires 2. In the bending control, the controller 100 controls the second grip actuator 92 to cause the second clamp 91 to grip the plurality of core wires 2. The controller 100 also controls the first grip actuator 22 to cause the first clamp 21 to release the multi-core cable 1. This will be described in more detail. The controller 100 controls the slide mechanism 93 to move the second clamp 91 inward in the left-right direction and to cause the second clamp 91 to grip the plurality of core wires 2. The controller 100 causes the first clamp 21 to release the multi-core cable 1. When the multi-core cable 1 is released, it is preferred that the first clamp 21 and the multi-core cable 1 are away from each other by about 1 mm. Alternatively, when the multi-core cable 1 is released, the first clamp 21 and the multi-core cable 1 may be in contact with each other. Herein, the expression “release” of the multi-core cable 1 indicates that the multi-core cable 1 is movable during the formation of the bent portion 2a. As a result, the core wire alignment apparatus 10 is put into the state shown in FIG. 8. During the above-described control, the bending device 30 is moved to the position shown in FIG. 7. The control of causing the protruding portion 42 to protrude from the main body 41, the control of causing the second clamp 91 to grip the plurality of core wires 2, the control of causing the first clamp 21 to release the multi-core cable 1, and the control of moving the bending device 30 may be performed in any order, or may be performed at the same time.

In the bending control, next, as shown in FIG. 9, the bending device 30 is closed. As a result, the protruding portion 42 of the first bending member 40 and the receiving portion 51 of the second bending member 50 form the bent portion 2a (see FIG. 10) in each of the plurality of core wires 2. In the bending control, the controller 100 drives the sandwich actuator 31 to cause the first bending member 40 and the second bending member 50 to be closer to each other and thus to cause the protruding portion 42 and the receiving portion 51 to sandwich the plurality of core wires 2, so that the bent portion 2a is formed in each of the plurality of core wires 2. Then, as shown in FIG. 10, the bending device 30 is opened.

The grip control is to cause the first clamp 21 to grip the multi-core cable 1 again such that the multi-core cable 1 is not moved while the core wires 2 are aligned by the alignment member 81. In this embodiment, the controller 100 performs the grip control after the bending control. In the grip control, the controller 100 controls the first grip actuator 22 to cause the first clamp 21 to grip the multi-core cable 1. In the grip control, the controller 100 controls the second grip actuator 92 to cause the second clamp 91 to release the plurality of core wires 2. Herein, the expression “release” of the core wires 2 indicates that the core wires 2 are movable during the alignment of the core wires 2 by the alignment member 81. The “release” of the core wires 2 may encompass a state where the second clamp 91 is in contact with the core wires 2. In a state where the core wires 2 are gripped by the second clamp 91 and are not movable as under the bending control, the core wires 2 are not aligned. Therefore, in the grip control, the second clamp 91 is caused to release the core wires 2. In this embodiment, only the top arm 91u of the second clamp 91 is driven by the top second grip actuator 92u to move upward, whereas the bottom arm 91d supports the plurality of core wires 2 without moving.

It should be noted that the grip control may be performed before the bending control. In this embodiment, at the time of the bending control, the core wires 2 are gripped by the second clamp 91 located to the front of the bent portions 2a. Therefore, the formation of the bent portions 2a causes a portion of the multi-core cable 1 that is to the rear of the bent portions 2a to move forward, whereas the tips of the core wires 2 are not moved. As a result, the positions of the tips of the plurality of core wires 2 after the bending control may be flush with each other more precisely. In a modification in which the grip control is performed before the bending control, at the time of the bending control, the multi-core cable 1 is gripped by the first clamp 21 located to the rear of the bent portions 2a. Therefore, the formation of the bent portions 2a causes the tips of the core wires 2 to move rearward, whereas a portion of the multi-core cable 1 that is to the rear of the bent portions 2a is not moved. In this case, the tips of the core wires 2 may move also in the up-down direction, and therefore, there is an undesirable possibility that the positions of the tips of the plurality of core wires 2 after the bending control are dispersed slightly. Instead, there is no need that the core wire alignment apparatus 10 includes the second grip device 90. For this reason, in one preferred modification, the grip control may be performed before the bending control. In this case, the grip control may only cause the first clamp 21 to grip the multi-core cable 1.

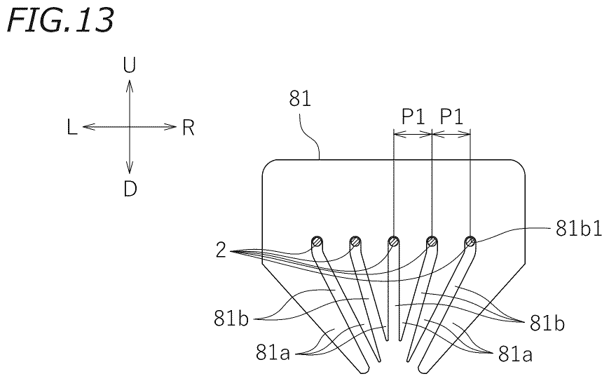

After the bending control and the grip control, the controller 100 performs the alignment control of controlling the insertion actuator 82 to insert the plurality of comb teeth 81a of the alignment member 81 between the plurality of core wires 2. This will be described in more detail. The controller 100 controls the insertion actuator 82 to move the alignment member 81 downward as shown in FIG. 12. As a result, as shown in FIG. 13, the plurality of core wires 2 are respectively inserted into the plurality of gaps 81b between the comb teeth 81a. As described above, immediately before the plurality of core wires 2 are respectively inserted into the plurality of gaps 81b, the plurality of core wires 2 and the gaps 81b have the positional relationship as shown in FIG. 11. When being inserted up to the top ends 81b1 of the gaps 81b, the plurality of core wires 2 are aligned in the left-right direction at a predetermined interval P1 as shown in FIG. 13.

At the time of the alignment control, the second clamp 91 “releases” the plurality of core wires 2 such that the core wires 2 are movable in the left-right direction, but may be in contact with the core wires 2 such that the core wires 2 are not easily movable in the front-rear direction. As described above, in this embodiment, among the arms of the second clamp 91, the bottom arm 91d, which is located to the front of the plurality of core wires 2 in the moving direction of the alignment member 81 in the alignment control (in this embodiment, the bottom arm 91d is located below the core wires 2), supports the plurality of core wires 2 at the time of the alignment control. At the time of the alignment control, the core wire restriction portions 96, which are located to the rear of the alignment member 81, restrict the movement of the core wires 2 in the up-down direction. Especially, the core wire restriction portion 96 that is below the core wires 2 restricts the plurality of core wires 2 such that the core wires 2 are not moved downward by being pressed by the alignment member 81. Supported by the bottom arm 91d and the core wire restriction portions 96 in this manner, the plurality of core wires 2 are inserted into the plurality of gaps 81b with certainty.

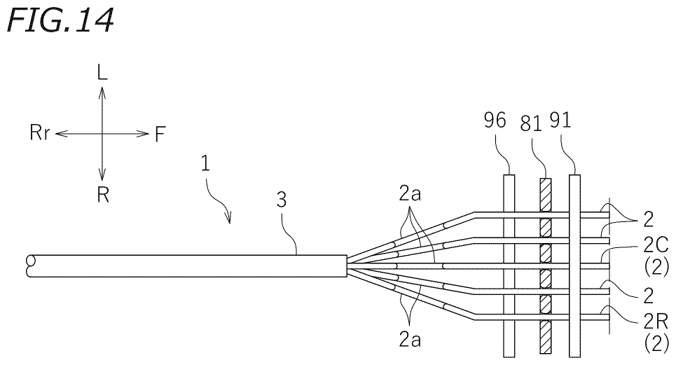

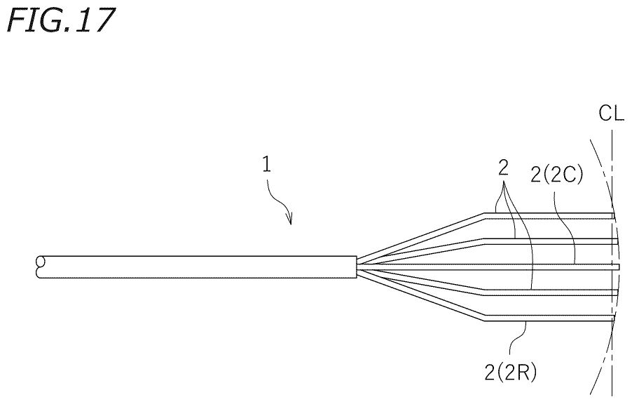

FIG. 14 is a plan view of the multi-core cable 1 in a state where the core wires 2 are aligned. FIG. 14 shows the state in FIG. 13 as seen from above. As shown in FIG. 14, when the core wires 2 are aligned by the core wire alignment apparatus 10 according to this embodiment, the positions of the tips of the plurality of core wires 2 are flush with each other at high precision. As described above, FIG. 17 is a plan view of the multi-core cable 1 including the core wires 2 aligned by the global pitch alignment jig disclosed in Patent Literature 1. In the case where the core wires 2 of the multi-core cable 1 are aligned by the global pitch alignment jig disclosed in Patent Literature 1, the tips of the core wires 2 at the center protrude more than the tips of the other core wires 2 for the reason described above. When the tips of the core wires 2 in such a state are cut along a straight line, the core wires 2 at the center are shorter than the other core wires 2. This may cause a problem.

By contrast, in the case where the core wires 2 are aligned by the core wire alignment apparatus 10 according to this embodiment, the bent portions 2a provide the core wires 2 with a margin for pulling occurring at the time of the alignment. For example, in FIG. 14, the central core wire 2C does not move almost at all even by being inserted into the alignment member 81. Therefore, the bent portion 2a of the central core wire 2C is not extended almost at all. By contrast, for example, the core wire 2R at the right end in FIG. 14 is moved rightward by being inserted into the alignment member 81. Therefore, the bent portion 2a of the core wire 2R at the right end is extended by some extent. The bent portion 2a is extended, so that the tip of the core wire 2R at the right end is not moved almost at all. For this reason, the core wire alignment apparatus 10 according to this embodiment may cause the positions of the tips of the plurality of aligned core wires 2 to be flush with each other at high precision. Therefore, even if the core wires 2 are not cut along a straight line, that may not possibly cause any problem. In the case where the core wires 2 are cut along a straight line, the plurality of core wires 2 have the same length, and also the positions of the tips thereof are flush with each other.

Next, as shown in FIG. 15, the controller 100 controls the retraction actuator 83 to pull out the alignment member 81 from the plurality of core wires 2. Although not shown, each of the components of the core wire alignment apparatus 10 are returned to an initial state thereof, and thus the process for aligning the plurality of core wires 2 is finished

### [Functions and Effects of the Embodiment]

Hereinafter, functions and effects provided by the core wire alignment apparatus 10 according to this embodiment will be described. The core wire alignment apparatus 10 according to this embodiment includes the bending device 30 forming the bent portions 2a between portions of the core wires 2 that are gripped by the first clamp 21 and portions of the core wires 2 between which the comb teeth 81a of the alignment member 81 are inserted. Before the alignment control, the controller 100 controls the bending device 30 to form each of the bent portions 2a in each of the plurality of core wires 2. With the core wire alignment apparatus 10 having such a configuration, the bent portions 2a act as a cushioning portion for pulling performed on the core wires 2 for the above-described reason. Therefore, the positions of the tips of the aligned core wires 2 can be flush with each other.

In this embodiment, the bending device 30 includes the first bending member 40 including the protruding portion 42 protruding in the direction crossing the axial direction of the core wires 2, and the second bending member 50 including the receiving portion 51, to which the protruding portion 42 is fittable. In the bending control, the controller 100 causes the first bending member 40 and the second bending member 50 to be closer to each other and to sandwich the plurality of core wires 2 by use of the protruding portion 42 and the receiving portion 51, thus to form the bent portion 2a in each of the plurality of core wires 2. With the core wire alignment apparatus 10 having such a configuration, the plurality of core wires 2 are sandwiched by the protruding portion 42 and the receiving portion 51, so that dispersion in the position and the shape of the bent portions 2a may be suppressed. The receiving portion 51, into which the protruding portion 42 is fittable, is a bottomless space between the two rollers 52 and 53 in this embodiment, but may be formed as a recessed portion with a bottom. There is no specific limitation on the configuration of the receiving portion 51.

In this embodiment, the plurality of comb teeth 81a have the plurality of gaps 81b formed therebetween, the plurality of gaps 81b respectively holding the plurality of core wires 2, and expand in a separation direction of the alignment member 81 (the separation direction is the upward direction in this embodiment) such that the plurality of gaps 81b are farther from each other as extending in the separation direction. With the core wire alignment apparatus 10 having such a configuration, the plurality of core wires 2 are respectively inserted into the plurality of gaps 81b, so that the interval between the plurality of aligned core wires 2 may be a desired interval (interval P1 in this embodiment) that is wider than the interval between the core wires 2 before the core wires 2 are aligned. In the case where the comb teeth 81a are set to have an appropriate sandwiching force, the core wires 2 are easily prevented from slipping in the gaps 81b in the front-rear direction. This allows the bent portions 2a to extend at the time of aligning the core wires 2 easily. As a result, the positions of the tips of the plurality of aligned core wires 2 are flush with each other more easily.

In this embodiment, the first bending member 40 includes the main body 41 capable of accommodating the protruding portion 42 or causing the protruding portion 42 to protrude therefrom. The core wire alignment apparatus 10 further includes the protrusion actuator 32 causing the protruding portion 42 to be accommodated in the main body 41 or to protrude from the main body 41, and the moving device 70 moving the first bending member 40 and the second bending member 50 in the tip direction of the core wires 2. The controller 100 performs, before the bending control, the straightening control of causing the first bending member 40 in a state of accommodating the protruding portion 42 and the second bending member 50 to be closer to each other and to sandwich the plurality of core wires 2, and also of controlling the moving device 70 to move the first bending member 40 and the second bending member 50 in the tip direction of the core wires 2. The controller 100 controls the protrusion actuator 32 to cause the protruding portion 42 to protrude after the straightening control but before the bending control. With the core wire alignment apparatus 10 having such a configuration, the straightening control is performed before the alignment control, so that the plurality of core wires 2 may be aligned preliminarily and extended straight. This allows the plurality of core wires 2 to be inserted into the alignment member 81 easily. In addition, the straightening control may be performed by use of the first bending member 40 and the second bending member 50, which are usable to form the bent portions 2a. Therefore, the number of the components of the core wire alignment apparatus 10 may be decreased.

The straightening control may be performed by use of a specific member for the work of straightening, instead of by use of the bending device 30. For example, the core wire alignment apparatus 10 may include a sandwich member capable of sandwiching the plurality of core wires 2 in a state where the multi-core cable 1 is gripped by the first clamp 21, a sandwich device driving the sandwich member to grip the plurality of core wires 2, and a moving device moving the sandwich member in the tip direction of the core wire 2 with respect to the first clamp 21. The controller 100 may perform, before the bending control, the straightening control of controlling the sandwich device to cause the sandwich member to sandwich the plurality of core wires 2, and also controlling the moving device to move the sandwich member in the tip direction of the core wire 2. The sandwich member in such a modification may include, for example, a member like the first bending member 40 with the protruding portion 42 being removed therefrom, and a member substantially the same as the second bending member 50. The sandwich device in such a modification may be, for example, substantially the same as the sandwich actuator 31. The moving device in such a modification may be, for example, substantially the same the moving device 70. The bending device 30 in such a modification may include a member like the first bending member 40 including the protruding portion 42 fixed thereto and a member substantially the same as the second bending member 50. The straightening control may be performed also by the core wire alignment apparatus 10 according to such a modification. It should be noted that the above-described configuration of the sandwich member and the like is merely an example, and there is no specific limitation on the configuration of the sandwich member and the like.

In this embodiment, the first bending member 40 and the second bending member 50 respectively include the plurality of first grooves 43a and the plurality of second grooves 52a formed therein, the plurality of first grooves 43a and the plurality of second grooves 52a respectively corresponding to the plurality of core wires 2 and being aligned in a direction in which the core wires 2 are aligned (in the left-right direction in this embodiment). The first bending member 40 and the second bending member 50 respectively contact the plurality of core wires 2 at the plurality of first grooves 43a and the plurality of second grooves 52a when sandwiching the plurality of core wires 2. With the core wire alignment apparatus 10 having such a configuration, the core wires 2 may be aligned by the first grooves 43a and the second grooves 52a preliminarily before the alignment control. This allows the plurality of core wires 2 to be inserted into the alignment member 81 more easily.

In this embodiment, the first bending member 40 includes the first alignment roller 43 including the plurality of first grooves 43a formed therein, the first alignment roller 43 being rotatable about an axis extending in the left-right direction. The second bending member 50 includes the second alignment roller 52 including the plurality of second grooves 52a formed therein, the second alignment roller 52 being rotatable about an axis extending in the left-right direction. With the core wire alignment apparatus 10 having such a configuration, the first alignment roller 43 and the second alignment roller 52 are rotated in the straightening control, and therefore, the first bending member 40 and the second bending member 50 may be moved smoothly. Even in the case where one of the first alignment roller 43 and the second alignment roller 52 is absent, substantially the same effect may be provided to some extent.

The core wire alignment apparatus 10 according to this embodiment includes the second clamp 91 provided to the front of the protruding portion 42 and the receiving portion 51 in a state of forming the bent portion 2a, and capable of gripping the plurality of core wires 2. In the bending control, the controller 100 causes the second clamp 91 to grip the plurality of core wires 2, and causes the first clamp 21 to release the multi-core cable 1. The controller 100 performs the grip control after the bending control. In the grip control, the controller 100 causes the first clamp 21 to grip the multi-core cable 1 and causes the second clamp 91 to release the plurality of core wires 2. With the core wire alignment apparatus 10 having such a configuration, the core wires 2 are gripped by the second clamp 91 located to the front of the bent portions 2a in the bending control, and therefore, the tips of the core wires 2 are not moved even though the bent portions 2a are formed. This allows the positions of the tips of the plurality of core wires 2 to be flush with each other more precisely after the bending control. On the other hand, the tips of the core wires 2 need to be moved in the alignment control, and therefore, the second clamp 91 releases the core wires 2 and the first clamp 21 grips the multi-core cable 1.

In this embodiment, the second clamp 91 includes the bottom arm 91d located to the front of (below in this embodiment) the plurality of core wires 2 in the moving direction of the alignment member 81 in the alignment control, and the top arm 91u located to the rear of (above in this embodiment) the plurality of core wires 2 in the moving direction of the alignment member 81. The bottom arm 91d and the top arm 91u sandwich the core wires 2 to grip the core wires 2. In the alignment control, the bottom arm 91d supports the plurality of core wires 2. With the core wire alignment apparatus 10 having such a configuration, the bottom arm 91d supports the core wires 2, so that escape of the core wires 2 due to the insertion of the alignment member 81 in the alignment control is suppressed. This allows the alignment of the core wires 2 to be performed more certainly.

### Other Embodiments

A preferred embodiment of the present invention is described above. However, the above-described embodiment is merely an example, and the present invention may be carried out in various other embodiments. For example, in the above-described embodiment, the bending device 30 includes the first bending member 40 including the protruding portion 42 and the second bending member 50 including the receiving portion 51, and sandwiches the plurality of core wires 2 between the protruding portion 42 and the receiving portion 51 to form the bent portion 2a in each of the plurality of core wires 2. However, the configuration of the bending device is not limited to this. For example, the bending device may include a second clamp provided to the front of the first clamp in the tip direction of the core wires 2 and capable of gripping the plurality of core wires 2, a second grip actuator driving the second clamp to grip the plurality of core wires 2, and a moving actuator causing the first clamp and the second clamp to be closer to each other. This configuration may be the same as that of the first embodiment, or may be different therefrom as long as not contradicting that of the first embodiment. With the embodiment described above in this paragraph, the controller may control the first grip actuator to cause the first clamp to grip the multi-core cable 1 and control the second grip actuator to cause the second clamp to grip the plurality of core wires 2 in the bending control. In addition, the controller may control the moving actuator to cause the first clamp and the second clamp to be closer to each other to form the bent portion 2a in each of the plurality of core wires 2. In other words, the controller may shorten the distance between the gripped two ends of the multi-core cable 1 to bend the core wires 2. The bending device may include a guide that determines the position of bending. Such a system may be combined with the first bending member 40, with the second bending member 50 or with both of the first bending member 40 and the second bending member 50 in the first embodiment.

In the above-described embodiment, in the straightening control, the alignment control and the like, the first clamp 21 is immovable, whereas the bending device 30 and the alignment member 81 are moved. However, the movement of one component with respect to the other component is relative, and there is no limitation on which component is movable. For example, in the straightening control and the like, the first clamp 21 may be moved, whereas the bending device 30 may be immovable. Alternatively, in the straightening control and the like, the both of the first clamp 21 and the bending device 30 may be moved. Similarly, in, for example, the alignment control and the like, the first clamp 21, the second clamp 91, the core wire restriction portion 96 and the like may be moved, whereas the alignment member 81 may be immovable. In the alignment control and the like, the alignment member 81 may be moved together with the other components.

In the above-described embodiment, the axial direction of the core wires 2 and the protruding direction of the bent portion 2a are perpendicular to each other, and the axial direction of the core wires 2 and the moving direction of the alignment member 81 are perpendicular to each other. However, it is sufficient that the axial direction of the core wires 2 and the protruding direction of the bent portion 2a cross each other, and do not need to be perpendicular to each other. Similarly, it is sufficient that the axial direction of the core wires 2 and the moving direction of the alignment member 81 cross each other, and do not need to be perpendicular to each other.

In the above-described embodiment, the straightening control is performed. However, the straightening control does not need to be performed. In the above-described embodiment, the first alignment roller 43, the second alignment roller 52 and other rollers are used in order to smoothly move the multi-core cable 1 with respect to the bending device 30. The rollers do not need to be provided. In the above-described embodiment, the plurality of core wires 2 are respectively inserted between the plurality of first grooves 43a and the plurality of second grooves 52a in order to preliminarily align the plurality of core wires 2. These grooves do not need to be provided. Alternatively, either one of the first grooves 43a or the second grooves 52a may be provided. Still alternatively, the first grooves 43a or the second grooves 52a do not need to correspond to the plurality of core wires 2 in a one-to-one relationship. For example, the first groove 43a and the second groove 52a may each be a wide groove such that all the core wires 2 are inserted between the first groove 43a and the second groove 52a.

Unless otherwise specified, the above-described embodiments do not limit the present invention in any way. For example, in the above-described embodiments, the insertion actuator 82 moves the alignment member 81 in the up-down direction to cause the first grip device 20 and the multi-core cable 1 gripped by the first grip device 20 to be closer to, or farther from, the alignment member 81. Regarding the relative movement of the components, either component may be moved, or both of the components may be moved. The components of the plurality of embodiments described above may be combined wherever possible.

### REFERENCE SIGNS LIST

1 Multi-core cable
2 Core wire
2a Bent portion
3 Sheath
10 Core wire alignment apparatus
20 First grip device
21 First clamp (first grip member)
22 First grip actuator (first driving portion)
30 Bending device
31 Sandwich actuator (third driving portion)
32 Protrusion actuator (fourth driving portion)
40 First bending member
41 Main body
42 Protruding portion
43 First alignment roller (first roller)
43a First groove
50 Second bending member
51 Receiving portion
52 Second alignment roller (second roller)
52a Second groove
70 Moving device
80 Alignment device
81 Alignment member
81a Comb tooth
81b Gap
82 Insertion actuator (second driving portion)
90 Second grip device
91 Second clamp (second grip member)
91d Bottom arm (first arm)
91u Top arm (second arm)
92 Second grip actuator (fifth driving portion)
100 Controller

1. A core wire alignment apparatus for a multi-core cable including a sheath and a plurality of core wires having tips thereof exposed from the sheath, the core wire alignment apparatus comprising:
a first grip member gripping the multi-core cable such that the plurality of exposed core wires are directed in a predetermined tip direction;
a first driving portion driving the first grip member to grip the multi-core cable;
an alignment member including a plurality of comb teeth and provided to the front of the first grip member in the tip direction;
a second driving portion moving at least one of the first grip member and the alignment member such that the plurality of comb teeth are inserted between the plurality of core wires,
a bending device forming bent portions protruding in a crossing direction crossing the tip direction, the bent portions being formed between portions of the core wires that are gripped by the first grip member and portions of the core wires into which the comb teeth are inserted, and
a controller controlling the first driving portion, the second driving portion and the bending device,
wherein the controller performs:
a grip control of controlling the first driving portion to cause the first grip member to grip the multi-core cable,
a bending control of controlling the bending device to form each of the bent portions in each of the plurality of core wires, and
an alignment control of, after the grip control and the bending control, controlling the second driving portion to insert the plurality of comb teeth between the plurality of core wires.

2. The core wire alignment apparatus for the multi-core cable according to claim 1, wherein:
the bending device includes:
a first bending member including a protruding portion protruding in the crossing direction,
a second bending member including a receiving portion to which the protruding portion is fittable, and
a third driving portion moving at least the first bending member in the crossing direction to cause the first bending member and the second bending member to be closer to each other,
wherein:
the first bending member and the second bending member are provided such that the protruding portion and the receiving portion face each other across the multi-core cable in a state of gripped by the first grip member, and
in the bending control, the controller drives the third driving portion to cause the first bending member and the second bending member to be closer to each other and to sandwich the plurality of core wires by use of the protruding portion and the receiving portion, thus to form the bent portion in each of the plurality of core wires.

3. The core wire alignment apparatus for the multi-core cable according to claim 2, wherein:
the first bending member includes a main body capable of accommodating the protruding portion or causing the protruding portion to protrude therefrom,
the core wire alignment apparatus further includes:
a fourth driving portion causing the protruding portion to be accommodated in the main body or to protrude from the main body, and
a moving device moving the first bending member and the second bending member in the tip direction with respect to the first grip member,
in a state where the protruding portion is accommodated in the main body, the first bending member and the second bending member are capable of sandwiching the plurality of core wires of the multi-core cable in a state of being gripped by the first grip member, and
the controller:
performs, before the bending control, a straightening control of causing the first bending member in a state of accommodating the protruding portion and the second bending member to be closer to each other and to sandwich the plurality of core wires, and also of controlling the moving device to move the first bending member and the second bending member in the tip direction, and
controls the fourth driving portion to cause the protruding portion to protrude after the straightening control but before the bending control.

4. The core wire alignment apparatus for the multi-core cable according to claim 3, wherein:
the first bending member includes a plurality of first grooves formed therein, the plurality of first grooves corresponding to the plurality of core wires and being aligned in a perpendicular direction perpendicular to the tip direction, and
the first bending member contacts the plurality of core wires at the plurality of first grooves when sandwiching the plurality of core wires together with the second bending member.

5. The core wire alignment apparatus for the multi-core cable according to claim 4, wherein the first bending member includes a first roller including the plurality of first grooves formed therein, the first roller being rotatable about an axis extending in the perpendicular direction.

6. The core wire alignment apparatus for the multi-core cable according to any one of claims 3 through 5, wherein:
the second bending member includes a plurality of second grooves formed therein, the plurality of second grooves corresponding to the plurality of core wires and being aligned in a perpendicular direction perpendicular to the tip direction, and
the second bending member contacts the plurality of core wires at the plurality of second grooves when sandwiching the plurality of core wires together with the first bending member.

7. The core wire alignment apparatus for the multi-core cable according to claim 6, wherein the second bending member includes a second roller including the plurality of second grooves formed therein, the second roller being rotatable about an axis extending in the perpendicular direction.

8. The core wire alignment apparatus for the multi-core cable according to any one of claims 2 through 7, further comprising:
a second grip member provided to the front of, in the tip direction, the protruding portion and the receiving portion in a state of forming the bent portion, and capable of gripping the plurality of core wires, and
a fifth driving portion driving the second grip member to grip the plurality of core wires,
wherein the controller:
in the bending control, controls the fifth driving portion to cause the second grip member to grip the plurality of core wires, and controls the first driving portion to cause the first grip member to release the multi-core cable, and
performs the grip control after the bending control, and in the grip control, controls the first driving portion to cause the first grip member to grip the multi-core cable and controls the fifth driving portion to cause the second grip member to release the plurality of core wires.

9. The core wire alignment apparatus for the multi-core cable according to claim 8, wherein:
the second grip member includes a first arm located to the front of the plurality of core wires in a moving direction of the alignment member in the alignment control, and a second arm located to the rear of the plurality of core wires in the moving direction of the alignment member in the alignment control, and
wherein in the alignment control, the first arm supports the plurality of core wires.

10. The core wire alignment apparatus for the multi-core cable according to claim 1, wherein:
the bending device includes:
a second grip member provided to the front of the first grip member in the tip direction and capable of gripping the plurality of core wires,
another driving portion driving the second grip member to grip the plurality of core wires, and
an actuator causing the first grip member and the second grip member to be closer to each other, and
in the bending control, the controller controls the first driving portion to cause the first grip member to grip the multi-core cable, controls the another driving portion to cause the second grip member to grip the plurality of core wires, and controls the actuator to cause the first grip member and the second grip member to be closer to each other, thus to form the bent portion in each of the plurality of core wires.

11. The core wire alignment apparatus for the multi-core cable according to claim 1, 2 or 10, further comprising:
a sandwich member capable of sandwiching the plurality of core wires in a state where the multi-core cable is gripped by the first grip member,
a sandwich device driving the sandwich member to grip the plurality of core wires, and
a moving device moving the sandwich member in the tip direction with respect to the first grip member,
wherein the controller performs, before the bending control, a straightening control of controlling the sandwich device to cause the sandwich member to sandwich the plurality of core wires, and also controlling the moving device to move the sandwich member in the tip direction.

12. The core wire alignment apparatus for the multi-core cable according to any one of claims 1 through 11, wherein:
where a direction, of the moving direction of the alignment member, in which the plurality of comb teeth are separated away from the plurality of core wires is a separation direction,
the plurality of comb teeth have a plurality of gaps formed therebetween, the plurality of gaps respectively holding the plurality of core wires, and expand in the separation direction such that the plurality of gaps are farther from each other as extending in the separation direction.
